(19) United States
(12) Patent Application Publication
(10) Pub. No.: US 2004/0073501 A1
(43) Pub. Date: Apr. 15, 2004

(54) Method and system for generating content management information

(75) Inventor: Haruhiko Kinoshita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/669,652

(22) Filed: Sep. 25, 2003

(30) Foreign Application Priority Data
Sep. 27, 2002 (JP) 2002-282700

(51) Int. Cl. G06F 17/60

(52) U.S. Cl. 705/30

(57) ABSTRACT

In processing for generating content management information, when a predetermined period has elapsed since a movie by use of a content was premiered, an itial information of the content is read. Subsequently, all pieces of utilization result information that have initial information which is on the same level as the initial information of the content are extracted from a database. Then, using the extracted utilization result information, an average value of utilization results for each of utilization modes is calculated, to generate content management information containing the calculation result. Based on the content management information, a content management agent predicts a result of utilizing the content in any other utilization modes in the future, to decide in which one of the utilization modes it is to be utilized. Therefore, it is possible to manage contents easily and effectively.

### BACKGROUND OF THE INVENTION

1. Field of the Invention

The present invention relates to a method and system for generating content management information used in determining a plan for utilizing contents in a plurality of utilization modes such as a movie, and to a program for causing a computer to execute processing for generating the content management information.

2. Description of the Related Art

Conventionally, when a movie is produced by a movie producer, a film of the movie is distributed to movie theaters where the movie is to be shown. Specifically, the movie producer shoots and edits a movie to create an edited film and, based on the film, creates a master film to be distributed. Subsequently, based on the distribution master film, an edited film is created as many as necessary and sent to a distribution agency. The distribution agency creates a large number of films based on the edited film it received and distributes the created film as a movie film to the movie theaters. When a showing period of the movie ends, the movie film is collected from each of the movie theaters.

In this distribution system, it is necessary to create many movie films and, in addition, distribute the movie films by delivery and then collect them, thus consuming much time and money.

Recently, such a system is proposed that a movie is given not as a movie film but as movie data in a form of electronic data, which movie data is delivered via a communication network to a distribution agency or a movie theater (see, for example, JP-A-2002-118834 and JP-A-2002-171471).

If, as described above, movie data is delivered by a movie producer through a communication network, the movie data can be easily delivered to a movie theater directly, so that a role of a distribution agency interposed between the movie producer and the movie theater could be deteriorated greatly.

In the system that the movie data is delivered via the communication network in such a manner, an importance of the distribution agency is deteriorated, so that its intermediary role may be eliminated.

Further, a movie produced by a movie producer is not only utilized when it is shown in a movie theater but also utilized in various modes. For example, it is recorded on a Digital Versatile Disc (DVD) or a video cassette to be sold, broadcast on a TV, or rented at a rental video store. However, for permitting the movie to be utilized in the variety of utilization modes, the movie producers must have a heavy management burden and so cannot focus their business resources on production of the movies, which is a problem. Furthermore, the movie producer can obtain information about movies he has produced for himself, but cannot easily obtain information about another movies, so that it is difficult for the movie producer to effectively utilize the movies in a variety of utilization modes, which is another problem.

On the other hand, unlike the movie producer, the distribution agency is involved in handling of a plurality of movies produced by a plurality of movie producers and so can easily collect a wide range of information about results of utilizing the movies in various utilization modes.

### SUMMARY OF THE INVENTION

An object of the present invention to eliminate the problems, and easily and effectively execute the management of contents such as movie data utilized in a variety of utilization modes.

According to the present invention, there is provided a method of generating a content management information (see FIG. 6, for example) used in determining a plan for utilizing contents in a plurality of utilization modes, comprising the steps of: saving initial information about an object content (for example, step S104); deciding whether initial information contained in each of a plurality of utilization result information indicating utilization results of other contents in the past is on the same level as the initial information of the object content (for example, step S203); extracting the utilization result information that contains the initial information decided to be on the same level (for example, step S203); and generating the content management information about the object content based on the extracted utilization result information (for example, step S204). By providing such a configuration, it is possible to easily and highly accurately design a plan for utilizing contents in a variety of utilization modes, thus managing the contents easily and effectively.

According to the present invention, there is provided another method of generating a content management information (see FIG. 8, for example) used in determining a plan for utilizing contents in a plurality of utilization modes, comprising the steps of: saving initial information about an object content (for example, step S104); deciding whether initial information contained in each of a plurality of utilization result information indicating utilization results of other contents in the past is on the same level as the initial information of the object content (for example, step S303); extracting the utilization result information that contains the initial information decided to be on the same level and that is indicative of any one of a top ranking predetermined number of utilization effects contained in the utilization results (for example, step S303); and generating the content management information about the object content based on the extracted utilization result information (for example, step S304). By providing such a configuration, it is possible to easily design, based on a successful example, a plan for utilizing contents in a variety of utilization modes, thus managing the contents easily and effectively.

Preferably the initial information contains results of utilizing the object content in a predetermined utilization mode at a predefined initial stage. By providing such a configuration, an actual utilization result obtained at the initial stage is used to predict a future utilization result based thereon, so that expectedly content management information can be generated highly accurately.

The configuration may be such that in case values indicated by the respective utilization results contained in a plurality of initial information are all in a predetermined range, the plurality of initial information are decided to be on the same level. By providing such a configuration, a utilization result of another content that has nearly the same actual utilization result at the initial stage is used to predict a future utilization result of the object contents, so that expectedly the content management information can be generated highly accurately.

Preferably the initial information contain, for example, a result of holding an event based on which the object content has been created. By providing such a configuration, a future utilization result is predicted on the basis of an actual utilization result of the event, so that expectedly the content management information can be generated highly accurately.

The configuration may be such that in case values indicated by the respective holding results contained in a plurality of initial information are all in a predetermined range, the plurality of initial information are decided to be on the same level. By providing such a configuration, a holding result of another content that has nearly the same actual holding result at the initial stage is used to predict a future utilization result of the object content, so that expectedly the content management information can be generated highly accurately.

The configuration may be such that the utilization result information contains the respective utilization results in a plurality of utilization modes and so is used to derive the respective average values in the plurality of utilization modes to thereby generate the content management information. By providing such a configuration, expectedly the content management information can be generated highly accurately for each of the plurality of utilization modes.

Preferably the content contains image data and also its utilization at least as movie data used in showing of a movie is included as one of the content utilization modes. By providing such a configuration, it is possible to easily design a plan for utilizing movie data in the variety of utilization modes, thus managing the movie data easily and effectively.

According to the present invention, there is provided a system for generating a content management information used in determining a plan for utilizing contents in a plurality of utilization modes, comprising: means for saving initial information about an object content; means for deciding whether initial information contained in each of a plurality of utilization result information indicating utilization results of other contents in the past is on the same level as the initial information of the object content; means for extracting the utilization result information that contains the initial information decided to be on the same level; and means for generating the content management information about the object content based on the extracted utilization result information. By providing such a configuration, it is possible to easily and highly accurately design a plan for utilizing contents in a variety of utilization modes, thus managing the contents easily and effectively.

According to the present invention, there is provide another system for generating a content management information used in determining a plan for utilizing contents in a plurality of utilization modes, comprising: means for saving initial information about an object content; means for deciding whether initial information contained in each of a plurality of utilization result information indicating utilization results of other contents in the past is on the same level as the initial information of the object content; means for extracting the utilization result information that contains the initial information decided to be on the same level and that is indicative of any one of a top ranking predetermined number of utilization effects contained in the utilization results; and means for generating the content management information about the object content based on the extracted utilization result information. By providing such a configuration, it is possible to easily design, based on a successful example, a plan for utilizing contents in a variety of utilization modes, thus managing the contents easily and effectively.

According to the present invention, there is provided a program for causing a computer to execute a method for generating a content management information used in determining a plan for utilizing contents in a plurality of utilization modes, the method comprising the steps of: saving initial information about an object content; deciding whether initial information contained in each of a plurality of utilization result information indicating utilization results of other contents in the past is on the same level as the initial information of the object content; extracting the utilization result information that contains the initial information decided to be on the same level; and generating the content management information about the object content based on the extracted utilization result information. By providing such a configuration, it is possible to easily and highly accurately design a plan for utilizing contents in a variety of utilization modes, thus managing the contents easily and effectively.

According to the present invention, there is provided another program for causing a computer to execute a method for generating a content management information used in determining a plan for utilizing contents in a plurality of utilization modes, the method comprising the steps of: saving initial information about an object content; deciding whether initial information contained in each of a plurality of utilization result information indicating utilization results of other contents in the past is on the same level as the initial information of the object content; extracting the utilization result information that contains the initial information decided to be on the same level and that is indicative of any one of a top ranking predetermined number of utilization effects contained in the utilization results; and generating the content management information about the object content based on the extracted utilization result information. By providing such a configuration, it is possible to easily design, based on a successful example, a plan for utilizing contents in a variety of utilization modes, thus managing the contents easily and effectively.

### BRIEF DESCRIPTION OF THE DRAWINGS

FIG. 1 is a block diagram for showing a configuration example of a content management information generation system;

FIG. 2 is an explanatory table of an example of content utilization result information;

FIG. 3 is a flow chart for showing an example of processing for acquiring initial information;

FIG. 4 is an explanatory illustration of an example of an initial information input screen;

FIG. 5 is a flow chart for showing an example of processing for generating content management information;

FIG. 6 is an explanatory illustration of an example of how the content management information is displayed;

FIG. 7 is a flow chart for showing an example of the processing for generating content management information according to another embodiment;

FIG. 8 is an explanatory illustration of an example of how the content management information is displayed according to the present embodiment; and

FIG. 9 is a block diagram for showing a configuration example of a computer system that constitutes a content management agent server.

### DESCRIPTION OF THE PREFERRED EMBODIMENTS

The following will describe one embodiment of the present invention with reference to drawings.

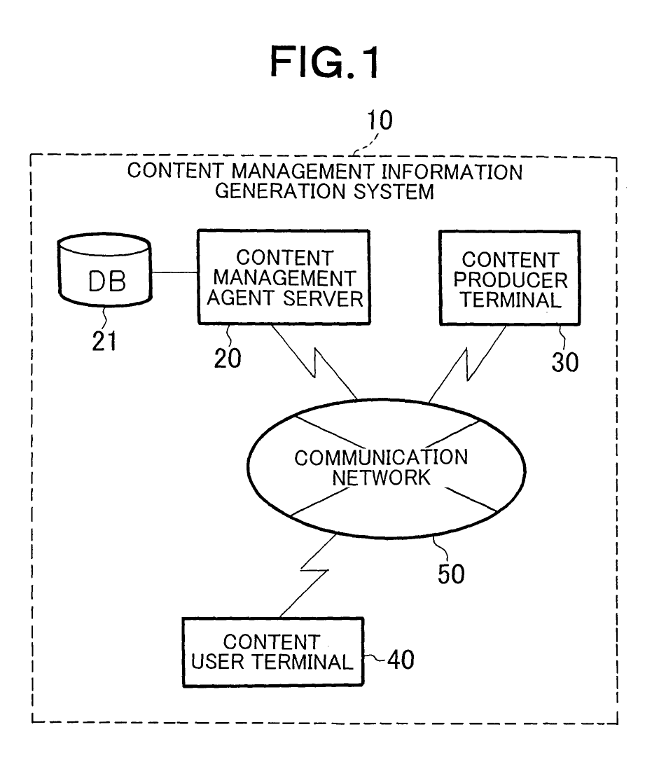

FIG. 1 is a block diagram for showing a configuration example of a content management information generation system 10. The content management information generation system 10 comprises a content management agent server 20, a content producer terminal 30, and a content user terminal 40. The content management agent server 20, the content producer terminal 30, and the content user terminal 40 are each connected to a communication network 50 such as the Internet. Although the content producer terminal 30 and the content user terminal 40 are each provided one in FIG. 1, they may be provided as many as necessary.

The present embodiment is supposed to use movie data used in showing of a movie film as a content delivered by the present system 10. The movie data may be an electronic data version of a film and so on used in shooting of the movie or electronic data of a picture taken at the time of photographing by use of a digital video camera and so on. A movie based on movie data may be comprised of any images such as real images, animations, or computer graphics.

The content management agent server 20 is constituted of an information processor such as an Internet server and managed by a system manager who manages the present system 10. The system manager may specifically be a so-called distributor in charge of, for example, publicity of movies. The content management agent server 20 has a function as a World Wide Web (WWW) server as well as a function to administer Web pages including a Web site for providing services such as acceptance of registration and alteration of a variety of kinds of information.

Further, the content management agent server 20 is provided with a database 21 for storing a variety of kinds of information including information acquired from a content producer, information acquired from a content user, and various information pieces about each of contents. Further, the content management agent server 20 has various functions such as a function to generate content management information used in order to manage contents effectively. In the present embodiment, the content management information is used when designing a plan for causing contents to be utilized effectively, thus predicting a future result of utilization in a plurality of utilization modes.

The content producer terminal 30 and the content user terminal 40 are each constituted of an information processor such as a personal computer. The content producer terminal 30 and the content user terminal 40 each have environments (hardware and software environments) in which they can be connected the communication network 50 such as the Internet and send and receive information over the communication network 50.

The content producer terminal 30 is managed by a content producer who produces contents. The content producer may specifically be a movie producer, for example.

The content user terminal 40 is managed by a content user who opens contents to public. The content user may specifically be a manager of, for example, a movie theater in which movies are shown.

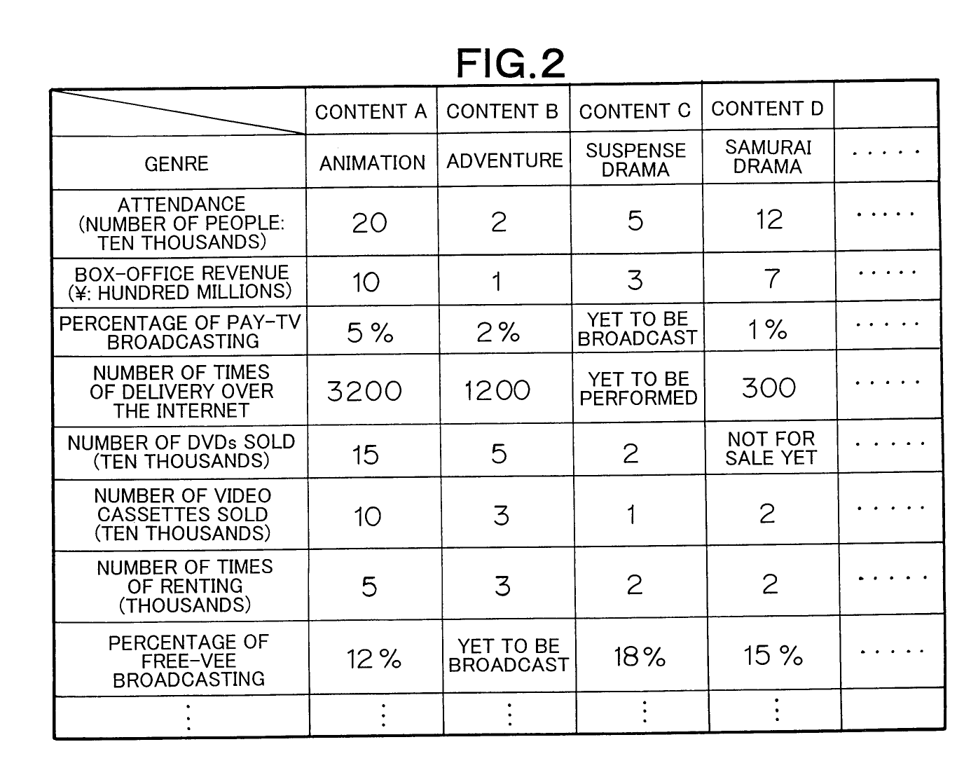

FIG. 2 is an explanatory table for showing an example of content utilization result information stored in the database 21. The content utilization result information includes information indicating a utilization result obtained when contents are utilized in each of various utilization modes. If the contents have been continuously utilized up to the moment, the content utilization result information indicates a result of utilization up to the moment.

Specifically, as shown in FIG. 2, the content utilization result information contains a content genre, an attendance obtained when a movie is shown in a movie theater, and a box-office revenue obtained when the movie is shown in the movie theater. In the present embodiment, especially those genre, attendance, and box-office revenue are handled as initial information. The initial information is comprised of information that indicates characteristics of the content such as a genre and information that indicates a result of utilizing the content in a utilization mode at an initial stage such as an attendance obtained when a movie is shown in a movie theater.

When its showing period in a movie theater ends, a content is typically utilized in various utilization modes such as pay-TV broadcasting, delivery over the Internet, sale or rental in a form of a Digital Versatile Disc (DVD) or a video cassette, and free-vee broadcasting. In the present embodiment, a result of utilization in a movie, which is a utilization mode where the content is utilized first, is handled as the initial information.

Further, as shown in FIG. 2, the content utilization result information contains information that indicates utilization results of contents in each of utilization modes such as a result of pay-TV broadcasting (for example, average audience rating), the number of times of delivery over the Internet, the number of DVDs sold, the number of video cassettes sold, the number of DVDs or video cassettes rented, and a result of free-vee broadcasting (for example, average audience rating).

The following will describe operations of the content management information generation system 10 of the present embodiment with reference to the drawings.

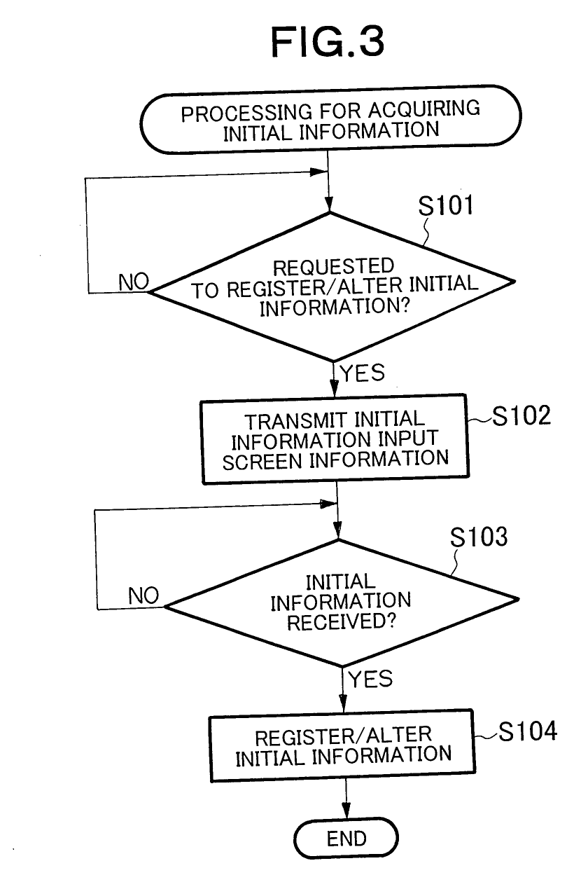

FIG. 3 is a flow chart for showing one example of processing for acquiring initial information in the content management information generation system 10 of the present embodiment.

In the example, the content management agent server 20 acquires information about a content C shown in a movie theater A from a manager of the movie theater A who manages the content user terminal 40, to execute processing reflected in information stored in the database 21. The manager of the movie theater A is supposed to register himself to the content management agent server 20 by using the content user terminal 40 beforehand to thereby acquire his user ID and password.

Further, in the present embodiment, it is supposed that if requested by the content producer terminal 30 who is managed by producer of the content C to distribute the content C, the content management agent server 20 acquires the content C via the communication network from the content producer terminal 30 and stores it in the database 21. Further, the content management agent server 20 distributes the content C to the content user terminal 40 managed in the movie theater A, for example, before the content C is premiered. Then, the content C distributed from the content management agent server 20 is used to show a movie in the movie theater A.

In processing for acquiring the initial information, when having received an access request from the content user terminal 40, the content management agent server 20 first requests a user to input his user ID and password. The access request is made by specifying a Uniform Resource Locator (URL) of the content management agent server 20. Then, the content management agent server 20 authenticates him by the user ID and the password input in response to the request, to accept access from the content user terminal 40. When accepted to make access, the content user terminal 40 requests the content management agent server 20 to register or alter the initial information in response to operations of the manager of the movie theater A. In this case, the initial information about the content C is requested to be registered if it is first to be done so, while it is requested to be altered if it is registered already by any one of the movie theaters for showing the content C.

When requested by the content user terminal 40 to register or alter the initial information (step S101), the content management agent server 20 transmits via the network 50 to the content user terminal 40 information of an initial information input screen required to display the initial information input screen (step S102).

When having acquired the initial information input screen information, the content user terminal 40 displays the initial information input screen based on the initial information input screen information on its own display (for example, an LCD).

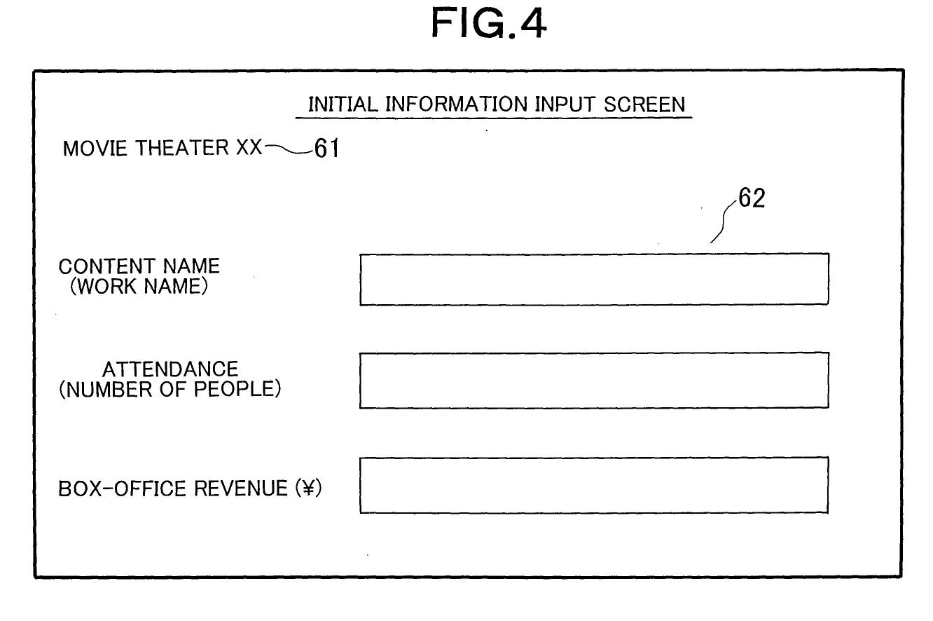

FIG. 4 is an explanatory illustration for showing one example of the initial information input screen. As shown in FIG. 4, the initial information input screen is comprised of a display region 61 for displaying a name of the movie theater A as an input of the initial information and an input region 62 for inputting the initial information of contents. As shown in FIG. 4, the initial conformation contains various kinds of information indicating a utilization result obtained by utilizing the content C each time a movie is shown in the movie theater A such as, for example, information to identify a content (for example, a content's work name, a work code assigned to each work), an attendance to the movie theater A over a predetermined period (for example, “Today” in a case where the initial information is posted every day or “past one week” in a case where the initial information is posted every week), and a box-office revenue at the movie theater A over the predetermined period. The initial information shown in FIG. 4 is just one example and may contain any other information about the utilization result obtained when the content C is utilized to show the movie such as, for example, an attendance for each generation, for each time zone, and for each sexes and an operation rate of a hall.

When the initial information input screen is displayed, the manager of the movie theater A uses an input device (for example, a keyboard or a mouse) of the content user terminal 40, to input into each item of the input region 62 the initial information of the content C at the movie theater A that he manages. In accordance with an instruction from the manager after he has input the initial information, the content user terminal 40 transmits the input initial information via the communication network 50 to the content management agent server 20.

If the initial information about the content C is registered already, the content management agent server 20, when having received the initial information about the content C (step S103), updates the initial information based on the already registered information and the received information (for example, adds an attendance to it) and stores the updated initial information in the database 21 (step S104). When having received the initial information about the content for the first time, on the other hand, it stores the received initial information as it is in the database 21 (step S104). When the initial information is newly registered or updated in such a manner, the initial information acquisition processing ends.

In the initial information acquisition processing, each time a notification of the initial information is received from each of movie theaters around the country where the content C is shown, it is reflected in the initial information about the content C in the database 21. Therefore, the initial information of the content C stored in the database 21 indicates an up-to-date total sum of attendances, an up-to-date total sum of box-office revenues, and so on.

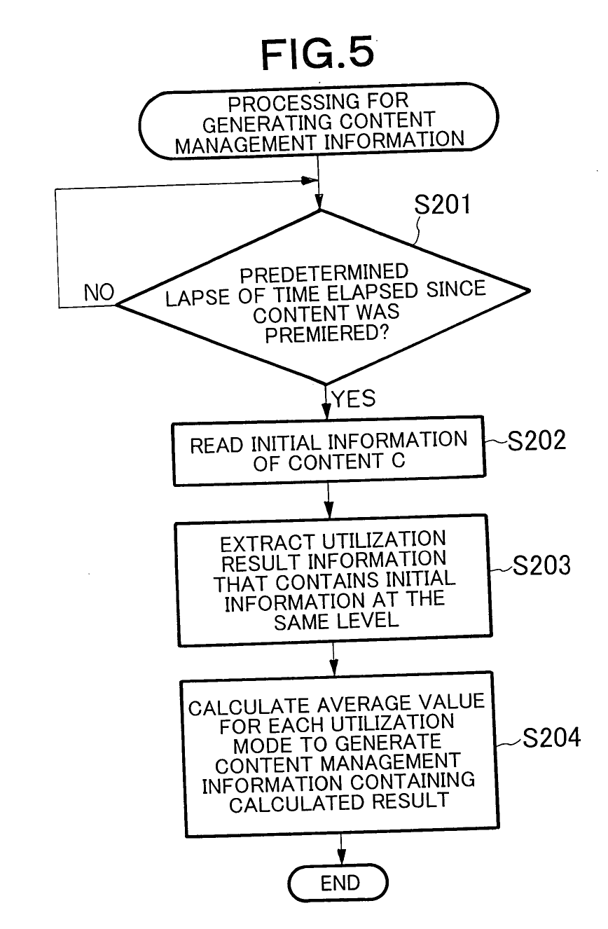

FIG. 5 is a flow chart for showing one example of processing for generating content management information in the content management information generation system 10 of the present embodiment.

In this flow, processing is executed for generating content management information about the content C as a reference material which is used by the content management agent server 20 when it creates a few utilization plans for how to utilize in the future the content C which is shown currently at movie theaters including the movie theater A around the country.

In the content management information generation processing, the content management agent server 20 first confirms whether a predetermined period has elapsed since the content C was premiered at the movie theaters around the country (step S201). For example, it confirms whether two weeks has elapsed since it was premiered. That is, in the present embodiment, based on a result of utilizing the content C as a movie over the predetermined period starting from the day of premiering, it predicts a future utilization result in other utilization modes and derives the prediction result as the content management information.

When the predetermined period has elapsed since the movie by use of the content C was premiered (step S201), the content management agent server 20 reads the initial information of the content C from the database 21 (step S202). In the present embodiment, the initial information thus read contains, for example, an attendance over the predetermined period starting from the day of premiering.

When the initial information of the content C is read, the content management agent server 20 extracts all pieces of utilization result information whose contents have been premiered in the past predetermined period and which have initial information on the same level as that of the content C from all pieces of utilization result information of a plurality of contents registered in the database 21 (step S203).

In the present embodiment, the utilization result information of only those contents that have been premiered in the past predetermined period is extracted at step S203. For a content that has passed many years since it was disclosed may not provide a reference because a market has changed, while a content disclosed recently may not provide a reference either because such a content is yet to be utilized widely in utilization modes other than movies. Therefore, a “past predetermined period” may be a period, for example, from five years ago to one year ago. Further, the “past predetermined period” may be replaced by a whole period or also a specific period in the past few years (specifically, for example, January when the content C was premiered).

Further, an expression of “initial information on the same level” used to extract all pieces of utilization result information pieces having initial information on the same level as that of the content C at step S203 is involved in a case where, for example, a utilization result obtained in a movie indicated by the initial information of the content C is the same or nearly the same as that in a movie indicated by the initial information of any other content. Specifically, if, for example, an attendance over two weeks since the content C is premiered is 95 thousands, initial information indicating that the attendance over the two weeks starting from the day of premiering has been, for example, between 90 thousands and 100 thousands is defined as “initial information on the same level”, so that utilization result information of a content that has such initial information is extracted at step S203.

Subsequently, the content management agent server 20 uses the utilization result information extracted at step S203, to calculate an average value of the utilization results for each of the utilization modes and generate content management information containing the calculation result (step S204).

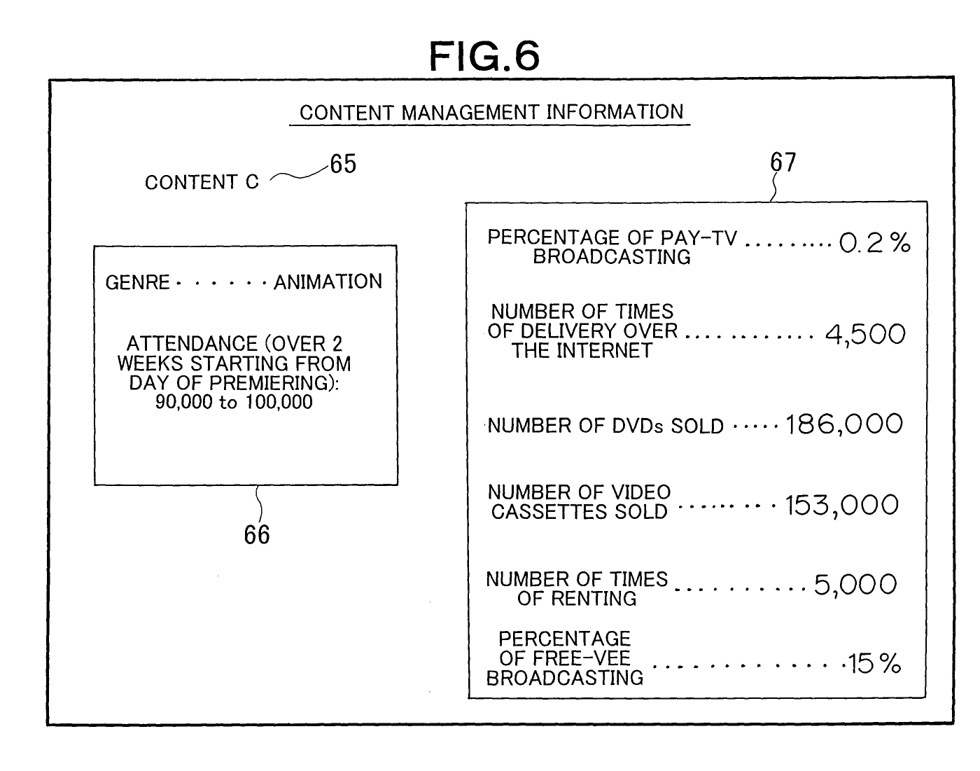

The generated content management information is displayed on a display screen of the content management agent server 20. The content management information display screen is comprised of a display region 65 for displaying a work name of an object content, a display region 66 for displaying extraction conditions employed when extracting the utilization result information at step S203, and a display region 67 for displaying an average value of utilization results for each of the utilization modes calculated at step S204 as shown in FIG. 6, for example. These information items displayed on the content management information display screen provide content management information.

The content management information shown in FIG. 6 is one example and may contain, for example, initial information of the content C, an average value of profits obtained as a utilization result in each of the utilization modes, an average value of a total sum of the profits, and so on.

Calculation of the average value at step S204 is one example, so that the content management information may be generated by calculating any other characteristic results (for example, results used to create a graph of a distribution).

Such information of the content management information as to be displayed in the display region 67 of the content management information display screen indicates an average of utilization results for each of the utilization modes. Therefore, it provides information that predicts a utilization result obtained when the content C is utilized in each of the utilization modes in the future. Based on the content management information, a content management agent who manages the content management agent server 20 can predict a utilization result of utilizing the content C at an early stage only after a predetermined period has elapsed since its utilization as a movie was started, to accurately decide in which one of the utilization modes it is to be utilized, thereby designing a highly accurate utilization plan easily.

As described above, in configuration, based on a result of utilizing a content in a movie and results of utilizing in other utilization modes other contents that have a utilization result on the same level as that of the content in the movie, a future utilization result of the content in the other potential utilization modes is predicted, so that by using the prediction result, it is possible to decide in which one of the utilization modes the content is to be utilized, thus designing a highly accurate utilization plan. Therefore, it is possible to manage the content in the variety of utilization modes easily and effectively.

Further, as described above, a utilization result in a predetermined utilization mode (movie in the above example) of the plurality of utilization modes obtained at a predefined utilization stage is provided as initial information, so that based on an actual utilization result at the early stage, a future utilization result in any other utilization modes is predicted, thus expectedly generating content management information highly accurately.

Further, as described above, in configuration, content management information is generated on the basis of utilization result information pieces having initial information on the same level, so that utilization results of other contents having nearly the same actual utilization result at the early stage can be used to predict a utilization result in the variety of utilization modes, thus expectedly generating the content management information highly accurately.

Further, as described above, in configuration, utilization result information containing the respective utilization results in a plurality of utilization modes is registered so that utilization result information pieces having initial information on the same level may be used to derive an average value in each of the plurality of utilization modes and contain it in content management information, thus expectedly generating the content management information highly accurately for each of the plurality of utilization modes.

Further, as described above, in configuration, a distribution agency is in charge of generating content management information and designing a content utilization plan, so that it is possible to improve a role value of the distribution agency, thus avoiding an intermediary role of the distribution agency from being eliminated even if movie data is delivered via a network. Further, in the above example, the distribution agency might utilize contents based on a utilization plan it has designed for itself in response to a request sent from a production company. Therefore, the production company can leave management of contents entirely to the distribution agency when they ask the agency for distribution of a movie, to thus be released entirely of a burden of managing the contents. Also, the production company can expect to get more profits by leaving the content management entirely to the distribution agency having utilization result information about various contents rather than utilizing the contents by designing a utilization plan for themselves.

Although the embodiment has been described with reference to such a configuration that at step S203 in the content management information generation processing, pieces of utilization result information containing initial information on the same level are all extracted, some of the pieces of utilization result information may be extracted.

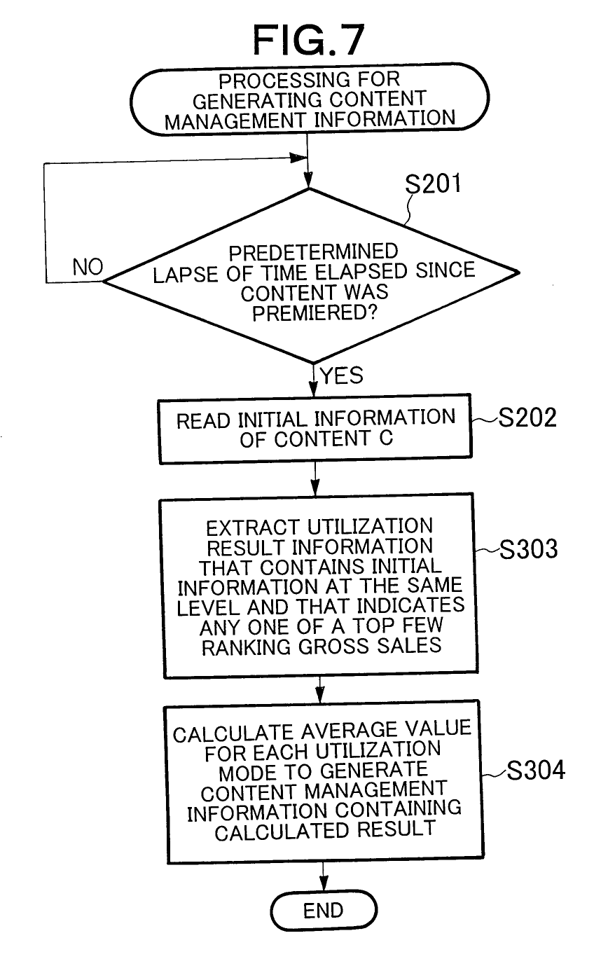

FIG. 7 is a flow chart for showing an example of the processing for generating content management information according to another embodiment. It is to be noted that components already described in FIG. 5 are indicated by the same reference symbols and so their detailed explanation is omitted.

When having read initial information of a content C at step S202, a content management agent server 20 extracts, from all pieces of utilization result information of a plurality of contents registered in a database 21, pieces of utilization result information whose relevant content has been premiered in, for example, a past predetermined period and has initial information on the same level as that of the content C and also which indicates any one of a top ranking few (for example, 10) gross sales (step S303).

That is, in the present example, the utilization result information contains sales proceeds in each of utilization modes and a gross sales in each of all the utilization modes.

Subsequently, the content management agent server 20 uses the utilization result information extracted at step S303, to calculate an average value of the utilization results for each of the utilization modes, thus generating content management information containing the calculation result (step S304).

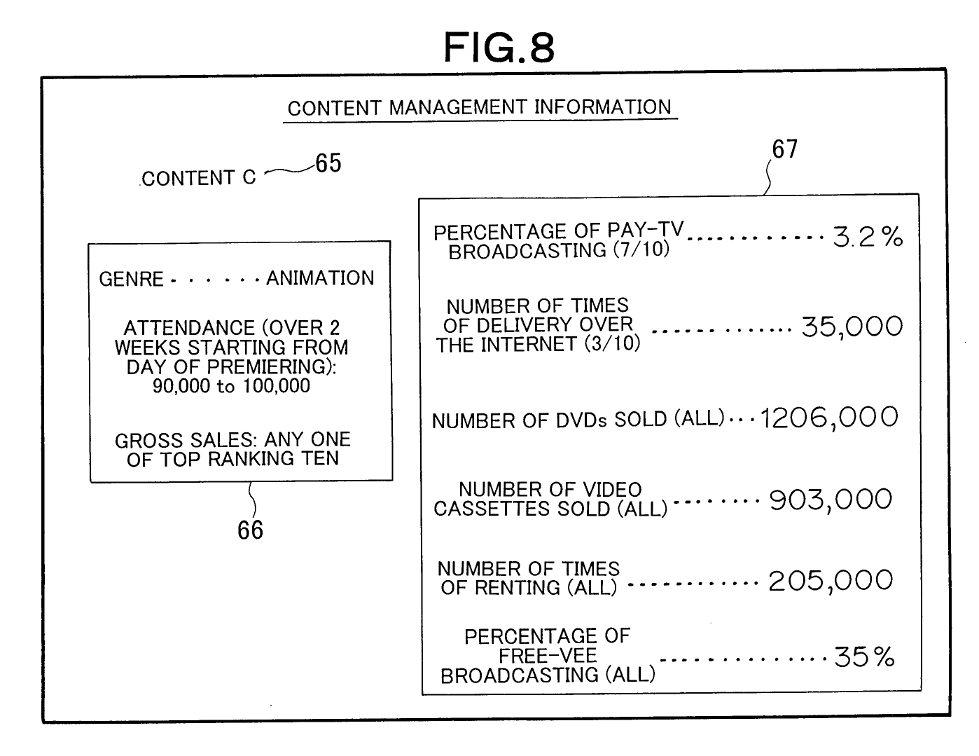

The generated content management information is displayed on a display screen of the content management agent server 20. The content management information display screen is comprised of a display region 65 for displaying a work name of an object content, a display region 66 for displaying extraction conditions employed when extracting the utilization result information at step S303, and a display region 67 for displaying an average value of utilization results for each of the utilization modes calculated at step S304 as shown in FIG. 8 for example. These information items displayed on the content management information display screen provide content management information. It is to be noted that in the present example, the display region 67 displays information that indicates how many contents utilized in each of the utilization modes are there of the ten extracted contents. Specifically, seven of the ten contents are broadcast on a pay TV and all of the ten contents are sold in a form of a DVD.

The information displayed in the display region 67 in FIG. 8 indicates an average of utilization results, in each of the utilization modes, of a predetermined number of top ranking contents, in gross sales, of all the contents utilized in the past in each of the utilization modes. That is, it indicates an average of utilization results of successful contents other than the content C that have initial information on the same level as that of the content C. Based on such content management information, the content management agent who manages the content management agent server 20 can gain an understanding of a pattern of utilization results that will turn to be successful when the content C is utilized in any other utilization modes in the future, at an early stage only after a predetermined period has elapsed since its utilization as a movie was started, to accurately decide in which one of the utilization modes it is to be utilized, thereby easily designing a highly accurate utilization plan expected to be successful commercially.

As described above, in configuration, based on a result of utilizing a content in a movie theater and results of utilizing in other utilization modes a predetermined number of top ranking other contents, in sales, that have a utilization result on the same level as that of the content in the movie, a future potential successful pattern of the content in the other utilization modes is predicted, so that by using the prediction result, it is possible to accurately decide in which one of the utilization modes the content is to be utilized, thus easily designing a utilization plan expected to be successful commercially. That is, it is possible to easily design a plan for utilizing a content utilized in a variety of utilization modes based on a successful example, thus managing the content easily and effectively.

Although this embodiment described above has employed such a configuration that an average value of utilization results in a successful example is derived, an order of the utilization modes in which the content is utilized, a utilization start timing (which is identified as “a specific number of days after a movie is premiered”, for example), a utilization area, and so on may also be derived on the basis of the utilization results of the successful example and contained in the content management information. In this case, utilization result information contains such information as a utilization start timing in each of the utilization modes, a utilization order, and a utilization area. Then, at step S304, the process might derive an order of the utilization modes in which the content C is utilized, a timing at which it starts to be utilized, an area where it is utilized, and so on based on the utilization result of each of the contents extracted at step S303. In this case, for example, the utilization order might be defined as the most frequently employed one of the utilization orders of the contents extracted at step S303, while the utilization timing might be defined as an average value of the utilization start timings of the contents extracted at step S303. By providing such a configuration, it is possible to contain also the utilization start timings in each of the utilization modes in the content management information, so that the content management information can be used as it is as a utilization plan.

Further, although in the above embodiments a content has been described as movie data, as far as it is utilized in a plurality of utilization modes, the content may be any other information such as software that records a concert or an event such as played on a living theater that is held in various facilities such as a community hall or a concert hall. Further, the content may be given in any form of information such as moving picture data, still picture data, or voice data.

For example, when using as the content such recorded data as to be of a concert held at a concert hall, an attendance at the concert hall and so on might be defined as initial information. That is, a result of holding an event based on which the content has been created might be defined as initial information. Then, based on utilization results in such other events in various utilization modes as to have come up with holding results on the same level as that indicated by the initial information, a result of utilizing the recorded data of the concert in each of the utilization modes might be predicted. In the case of such a configuration, based on an actual utilization result in the event, a future utilization result is predicted, so that expectedly content management information can be generated highly accurately.

Besides the various utilization modes exemplified in the above embodiments, such a utilization mode may be added as sales of items such as characters who appear in a content rather than utilization of the content itself.

Although the above embodiments have employed such a configuration that movie data as a content is transmitted via the communication network 50, preferably the movie data, before being delivered, is compressed to reduce a communication load or encrypted to prevent leakage of information. Further, before it transmits the movie data, the content management agent server 20 may convert a format of the movie data into such a format as to match a utilization mode employed at a transmission destination.

When delivering contents to content users, data of the contents might be provided in a batch, for example. In this case, the content user may save the contents and use data of the stored content to thereby utilize the contents (show a movie, for example). Further, for example, the content data may be provided by a method referred to as streaming. In this case, the content user reproduces the contents based on the received data while receiving the contents simultaneously.

Further, although the above embodiments have employed such a configuration that content management information is generated when a predetermined period has elapsed since a content was premiered, for example, the manager of the server 20 of the present system 10 may execute, based on a specified content name, content management information generation processing required to generate content management information for the content. In this case, for example, a total sum of attendances over a period from a day when the content is premiered to a day when the content name is specified might be defined as initial information.

Although not having been mentioned in particular in the above embodiments, processing for charging a movie theater or a distribution agency may be executed in any manner. For example, a production cost and an advertisement cost of a movie, its attendance in a movie theater, its admission fee, and so on may be managed at the present system 10 so that the server 20 of the present system 10 can calculate the respective shares of a producer, the movie theater, and the distribution agency to execute various kinds of processing such as instructing a server operated by a financial institution to transfer a predetermined amount of money from a specified account of the movie theater to a specified account of the producer.

Although not having been mentioned in particular in the above embodiments, a determined content utilization plan may be registered in configuration at the content management agent server 20, which in turn delivers the contents in accordance with the content utilization plan. For example, when a timing defined in the utilization plan for starting preparation for selling the content as a DVD is encountered, the content management agent server 20 automatically delivers the content to a terminal device of an agency that executes processing of recording the content on, for example, a DVD. In this case, a content delivery timing and a content delivery destination might be contained in the utilization plan.

Although the above embodiments have employed such a configuration that various kinds of information are transferred via the communication network 50, the various kinds of information such as initial information may be transferred partially or wholly by sending by mail a recording medium in which data is recorded or a form filled out with the data.

Although not having been mentioned in particular in the above embodiments, the content management agent server 20 operates in accordance with a control program (content management information generation program) for causing the various kinds of processing to be executed. The control program causes the content management agent server 20 to execute processing for saving initial information about an object content, processing for deciding whether the respective initial information pieces contained in a plurality of utilization result information pieces indicating utilization results of other contents utilized in the past are on the same level as the initial information of the object content, processing for extracting the utilization result information containing the initial information decided to be on the same level, and processing for generating content management information about the object content based on the extracted utilization result information.

The control program causes the content management agent server 20 to execute processing for saving initial information about an object content, processing for deciding whether the respective initial information pieces contained sin a plurality of utilization result information pieces indicating utilization results of other contents utilized in the past are on the same level as the initial information of the object content, processing for extracting the utilization result information that contains the initial information decided to be on the same level and that is indicative of any one of a top ranking predetermined number of utilization effects contained in the utilization results, and processing for generating content management information about the object content based on the extracted utilization result information.

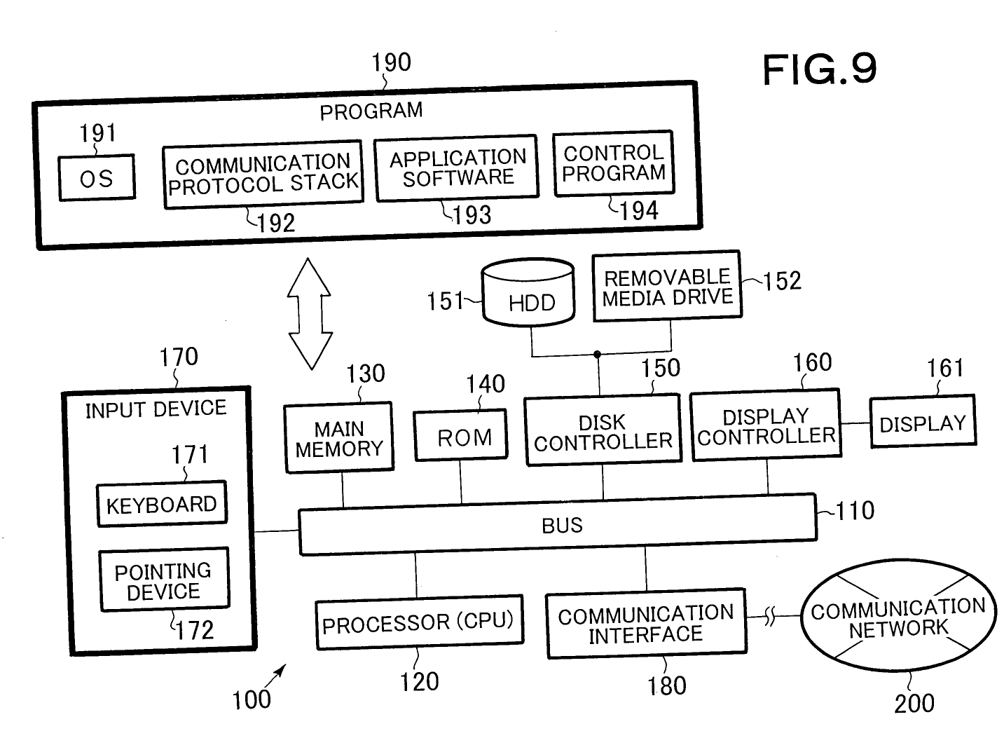

In one example, the content management agent server 20 and the database 21 that are shown in FIG. 1 are integrated into a computer system 100 shown in FIG. 9.

The computer system 100 shown in FIG. 9 has components connected to a bus 110 such as a processor (CPU) 120 in charge of information processing in the present system 100, a main memory 130, a Read Only Memory (ROM) 140, a disk controller 150, a display controller 160, an input device 170, and a communication interface 180. The communication interface 180 is communicatively connected to a communication network 200, which corresponds to the communication network 50 shown in FIG. 1. The communication network 200 may be a network such as a Local Area Network (LAN) or a Wide Area Network (WAN), a phone line, a public circuit such as ISDN, or a leased circuit. Further, the communication network 200 may not only be a wire circuit but also be a wireless circuit such as a wireless LAN as occasion demands.

The main memory 130 is constituted of a Random Access Memory (RAM) such as a Dynamic RAM (DRAM) or a Static RAM (SRAM) and can store program instructions that are executed by the processor 120 and information and also can store information and so on temporarily generated during the execution of the program instructions by the processor 120.

The ROM 140 is constituted of, for example, a programmable ROM (PROM), an Erasable and Programmable ROM (EPROM), or an Electrically Erasable and Programmable ROM (EEPROM) and stores fixed information and instructions processed by the processor 120.

To the disk controller 150, a Hard Disk Drive (HDD) 151 and/or a removable media drive (magnetic disk, optical disc, magnetic optical disk, and so on) 152 are connected. The HDD 151 and/or the removable media drive 152 are driven by the disk controller 150, to store various kinds of information and instructions processed by the processor 120.

To the display controller 160, a display 161 such as a Cathode Ray Tube (CRT) or a Liquid Crystal Display (LCD) is connected. The display 161 is driven by the disk controller 160, to display various kinds of information (see FIGS. 4, 6, and 8, for example) as instructed by the processor 120.

The input device 170 is constituted of, for example, a keyboard 171 or a pointing device (for example, mouse) 172. The input device 170 sends to the processor 120 a variety of kinds of information or instructions that are, for example, input, instructed, or selected by a user's operation.

The communication interface 180 is constituted of a network interface connectable to, for example, a LAN or an ADSL (Asymmetric Digital Subscriber Line) card, an ISDN (Integrated Services Digital Network) card, a MODEM (MOdulator-DEModulator), and so on connectable to a phone line and connected to the communication network 200 via the LAN or the phone line. The communication interface 180 communicates with a communication node such as other servers, transponders (for example, routers), or terminals via the communication network 200 by transferring signals that carry various kinds of information in accordance with a predetermined communication protocol.

In this configuration, the database 21 shown in FIG. 1 is built in, for example, the HDD 151.

Further, a program (the OS (Operating System) 191, a communication protocol stack 192 such as TCP (Transmission Control Protocol)/IP (Internet Protocol), various pieces of application software 193 such as a Web (WWW: World Wide Web) server) 190 including the control program 194 executed by the content management agent server 20 shown in FIG. 1 is stored on a recording medium such as the ROM 140 or the HDD 151 in the system 100. When the program 190 is executed and processed by the processor 120, the processing steps shown in, for example, the flowcharts of FIGS. 3, 5, and 7 are executed.

Further, a computer system that constitutes the terminal shown in FIG. 1 (the content producer terminal 30 or the content user terminal 40) is basically similar to the server described above in hardware configuration and so its description is omitted. However, this terminal, if constituted of a wireless communication terminal such as a cellular phone or a Personal Digital Assistance (PDA), is provided with, in addition to the configuration described above, a wireless communication unit that can communicate data using radio waves having a predetermined frequency determined by a wireless circuit employed.

This terminal comprises, in software configuration, the program (the OS, the communication protocol stack such as TCP/IP, the various pieces of application software such as a Web browser and so on) including the control program of the present embodiment. This program is stored in a recording medium in the system such as the ROM or the hard disk and executed by the processor. When the program is executed by the processor, each of the processing items on the side of the terminal that corresponds to each of the processing steps on the side of the server shown in FIGS. 3, 5, and 7 is executed.

What is claimed is:

1. A method for generating a content management information used in determining a plan for utilizing contents in a plurality of utilization modes, comprising the steps of:
saving initial information about an object content;
deciding whether initial information contained in each of a plurality of utilization result information indicating utilization results of other contents in the past is on the same level as the initial information of the object content;
extracting the utilization result information that contains the initial information decided to be on the same level; and
generating the content management information about the object content based on the extracted utilization result information.

2. A method for generating a content management information used in determining a plan for utilizing contents in a plurality of utilization modes, comprising the steps of:
saving initial information about an object content;
deciding whether initial information contained in each of a plurality of utilization result information indicating utilization results of other contents in the past is on the same level as the initial information of the object content;
extracting the utilization result information that contains the initial information decided to be on the same level and that is indicative of any one of a top ranking predetermined number of utilization effects contained in the utilization results; and
generating the content management information about the object content based on the extracted utilization result information.

3. The method according to claim 1, wherein the initial information contains the utilization result of the object content in a predetermined utilization mode at a predefined initial stage.

4. The method according to claim 3, wherein in case values indicated by the respective utilization results contained in the plurality of initial information are all in a predetermined range, the plurality of initial information are decided to be on the same level.

5. The method according to claim 1, wherein the initial information contains a holding result of an event based on which the object content has been created.

6. The method according to claim 5, wherein in case values indicated by the respective holding results contained in the plurality of initial information are all in a predetermined range, the plurality of initial information are decided to be on the same level.

7. The method according to claim 1, wherein the utilization result information contains the respective utilization results in the plurality of utilization modes; and
the extracted utilization result information is used to thereby derive an average value in each of the plurality of utilization modes.

8. The method according to claim 1, wherein the content contains image data; and
a mode of utilizing the content as data of a movie used at least when showing the movie is included as one of the modes of utilizing the content.

9. A system for generating a content management information used in determining a plan for utilizing contents in a plurality of utilization modes, comprising:
means for saving initial information about an object content;
means for deciding whether initial information contained in each of a plurality of utilization result information indicating utilization results of other contents in the past is on the same level as the initial information of the object content;
means for extracting the utilization result information that contains the initial information decided to be on the same level; and
means for generating the content management information about the object content based on the extracted utilization result information.

10. A system for generating a content management information used in determining a plan for utilizing contents in a plurality of utilization modes, comprising:
means for saving initial information about an object content;
means for deciding whether initial information contained in each of a plurality of utilization result information indicating utilization results of other contents in the past is on the same level as the initial information of the object content;
means for extracting the utilization result information that contains the initial information decided to be on the same level and that is indicative of any one of a top ranking predetermined number of utilization effects contained in the utilization results; and
means for generating content management information about the object content based on the extracted utilization result information.

11. The system according to claim 9, wherein the initial information contains the utilization result of the object content in a predetermined utilization mode at a predefined initial stage.

12. The system according to claim 11, wherein in case values indicated by the respective utilization results contained in the plurality of initial information are all in a predetermined range, the plurality of initial information are decided to be on the same level.

13. The system according to claim 9, wherein the initial information contains a holding result of an event based on which the object content has been created.

14. The system according to claim 13, wherein if values indicated by the respective holding results contained in the plurality of initial information are all in a predetermined range, the plurality of initial information are decided to be on the same level.

15. The system according to claim 9, wherein the utilization result information contains the respective utilization results in the plurality of utilization modes; and
the extracted utilization result information is used to thereby derive an average value in each of the plurality of utilization modes.

16. The system according to claim 9, wherein the content contains image data; and
a mode of utilizing the content as data of a movie used at least when showing the movie is included as one of the modes of utilizing the content.

17. A program for causing a computer to execute a method for generating a content management information used in determining a plan for utilizing contents in a plurality of utilization modes, the method comprising the steps of:
saving initial information about an object content;
deciding whether initial information contained in each of a plurality of utilization result information indicating utilization results of other contents in the past is on the same level as the initial information of the object content;
extracting the utilization result information that contains the initial information decided to be on the same level; and
generating the content management information about the object content based on the extracted utilization result information.

18. A program for causing a computer to execute a method for generating a content management information used in determining a plan for utilizing contents in a plurality of utilization modes, the method comprising the steps of:
saving initial information about an object content;
deciding whether initial information contained in each of a plurality of utilization result information indicating utilization results of other contents in the past is on the same level as the initial information of the object content;
extracting the utilization result information that contains the initial information decided to be on the same level and that is indicative of any one of a top ranking predetermined number of utilization effects contained in the utilization results; and
generating the content management information about the object content based on the extracted utilization result information.

19. The program according to claim 17, wherein the initial information contains the utilization result of the object content in a predetermined utilization mode at a predefined initial stage.

20. The program according to claim 19, wherein in case values indicated by the respective utilization results contained in the plurality of initial information are all in a predetermined range, the plurality of initial information are decided to be on the same level.

21. The program according to claim 17, wherein the initial information contains a holding result of an event based on which the object content has been created.

22. The program according to claim 21, wherein in case values indicated by the respective holding results contained in the plurality of initial information are all in a predetermined range, the plurality of initial information are decided to be on the same level.

23. The program according to claim 17, wherein the utilization result information contains the respective utilization results in the plurality of utilization modes; and
the extracted utilization result information is used to thereby derive an average value in each of the plurality of utilization modes.

24. The program according to claim 17, wherein the content contains image data; and
a mode of utilizing the content as data of a movie used at least when showing the movie is included as one of the modes of utilizing the content.
